(19) United States
(12) Patent Application Publication
(10) Pub. No.: US 2025/0200265 A1
(43) Pub. Date: Jun. 19, 2025

(54) MIS-ALIGNMENT DETECTION METHOD FOR SEMICONDUCTOR DEVICE AND SEMICONDUCTOR DEVICE MANUFACTURING METHOD INCLUDING THE MIS-ALIGNMENT DETECTION METHOD

(71) Applicant: Samsung Electronics Co., Ltd., Suwon-si (KR)

(72) Inventors: Ingyun CHUNG, Suwon-si (KR); Dongjin PARK, Suwon-si (KR)

(73) Assignee: Samsung Electronics Co., Ltd., Suwon-si (KR)

(21) Appl. No.: 18/779,246

(22) Filed: Jul. 22, 2024

(30) Foreign Application Priority Data
Dec. 18, 2023 (KR) 10-2023-0185072

(51) Int. Cl. G06F 30/398

(52) U.S. Cl. CPC G06F 30/398

(57) ABSTRACT

The inventive concepts provide a mis-alignment (MA) detection method for a semiconductor device, the MA detection method comprising; inputting size information about a unit cell block of the semiconductor device, generating a finite element method (FEM) model based on the size information, calculating a residual stress function of the unit cell block using the FEM model, generating a bulk layer effect (BLE) prediction algorithm for the unit cell block by inputting the residual stress function into an initial BLE prediction algorithm generated based on a main cell block of the semiconductor device, and selectively detecting the MA of the unit cell block using the BLE prediction algorithm.

### CROSS-REFERENCE TO RELATED APPLICATION

This application is based on and claims ranking under 35 U.S.C. § 119 to Korean Patent Application No. 10-2023-0185072, filed on Dec. 18, 2023 in the Korean Intellectual Property office, the disclosure of which is incorporated by reference herein in its entirety.

### BACKGROUND

The inventive concepts relate to a semiconductor device manufacturing method, and more particularly, to a mis-alignment detection method of detecting mis-alignment for a semiconductor device and a semiconductor device manufacturing method including the mis-alignment detection method.

As the high integration of memory products accelerates due to the recent rapid development of refined semiconductor process technology, the unit cell area is reduced, and the operating voltage is reduced. For example, the area occupied by the semiconductor devices such as dynamic random access memory (DRAM) has been reduced as the degree of integration increases, while the required capacitance may need to be maintained or increased. As the required capacitance increases, the aspect ratio of the capacitors increases, and accordingly, the capacitors may be tilted or collapsed.

### SUMMARY

The inventive concepts provide a mis-alignment (MA) detection method for a semiconductor device to accurately predict and detect the MA in the semiconductor device, and a semiconductor device manufacturing method including the MA manufacturing method.

In addition, the issues to be solved by the technical idea of the inventive concepts example embodiments are not limited to those mentioned above, and other issues may be clearly understood by those of ordinary skill in the art from the following descriptions.

According to various example embodiments of the inventive concepts, there is provided a mis-alignment (MA) detection method for a semiconductor device, the MA detection method comprising; inputting size information about a unit cell block of the semiconductor device, generating a finite element method (FEM) model based on the size information, calculating a residual stress function of the unit cell block using the FEM model, generating a bulk layer effect (BLE) prediction algorithm for the unit cell block by inputting the residual stress function into an initial BLE prediction algorithm generated based on a main cell block of the semiconductor device, and selectively detecting the MA of the unit cell block using the BLE prediction algorithm.

In addition, according to other various example embodiments of the inventive concepts, there is provided a mis-alignment (MA) detection method for a semiconductor device, the MA detection method comprising; inputting size information about a unit cell block to be calculated of a dynamic random access memory (DRAM) device, generating a finite element method (FEM) model based on the size information, calculating a residual stress function of the unit cell block by using the FEM model, generating a bulk layer effect (BLE) prediction algorithm for the unit cell block by inputting the residual stress function to an initial BLE prediction algorithm generated based on a main cell block of the DRAM device, determining whether a size of the unit cell block has been changed, and by using the BLE prediction algorithm, selectively detecting the MA of a capacitor of the DRAM device in the unit cell block. The BLE is a phenomenon in which a mold pattern used for forming a capacitor of the semiconductor device is bent toward a center of the unit cell block due to stress. In response to determining the size of the unit cell block has been changed, the size information is input. In response to determining the size of the unit cell block has not been changed, the detecting the MA is performed.

Furthermore, according to other various example embodiments of the inventive concepts, there is provided a semiconductor device manufacturing method, the method comprising; inputting size information about a unit cell block to be calculated of a semiconductor device, generating a finite element method (FEM) model based on the size information, calculating a residual stress function of the unit cell block by using the FEM model, generating a bulk layer effect (BLE) prediction algorithm for the unit cell block by inputting the residual stress function to an initial BLE prediction algorithm generated based on a main cell block of the semiconductor device, determining whether a size of the unit cell block has been changed, selectively detecting mis-alignment (MA) of the unit cell block by using the BLE prediction algorithm, and reflecting the MA on a mask for forming a pattern of the semiconductor device. In response to determining the size of the unit cell block changing, the size information is input. In response to determining the size of the unit cell block having not been changed, the detecting the MA is performed.

### BRIEF DESCRIPTION OF THE DRAWINGS

Various example embodiments will be more clearly understood from the following detailed description taken in conjunction with the accompanying drawings in which:

FIG. 1 is a schematic flowchart of a process of a mis-alignment detection method for a semiconductor device, according to various example embodiments;

FIGS. 2A and 2B are cross-sectional views of an SEM photo and a portion of the SEM photo for explaining an issue of inclination of capacitors in a cell block of a DRAM device, respectively;

FIGS. 3A through 3C are a plan view and cross-sectional views of a unit cell block for explaining a reason of inclination of capacitors in a cell block of a DRAM device, respectively;

FIGS. 4A through 4C are conceptual diagrams for explaining an operation of generating a finite element method (FEM) model and operations of calculating a residual stress function in the mis-alignment detection method for the semiconductor device of FIG. 1;

FIGS. 5A and 5B are conceptual diagrams of an FEM model for unit cell blocks of different shapes;

FIGS. 6A through 6C are a plan view of main cell blocks and graphs of mis-alignment of a capacitor detected by the mis-alignment detection method for the semiconductor device of the inventive concepts compared with data measured by a scanning electron microscope (SEM), respectively;

FIGS. 7A through 12C illustrate plan views of various types of unit cell blocks, and graphs of comparing mis-alignment of a capacitor detected by using the mis-alignment detection method on a comparative model, the mis-alignment of a capacitor detected by using the mis-alignment detection method of the various example embodiments, and data measured by using the SEM, corresponding to the plan views; and

FIG. 13 is a schematic flowchart of processes of a semiconductor element manufacturing method according to various example embodiments.

### DETAILED DESCRIPTION

Hereinafter, various example embodiments of the inventive concepts will be described in detail with reference to the accompanying drawings. Identical reference numerals are used for the same constituent elements in the drawings, and duplicate descriptions thereof are omitted.

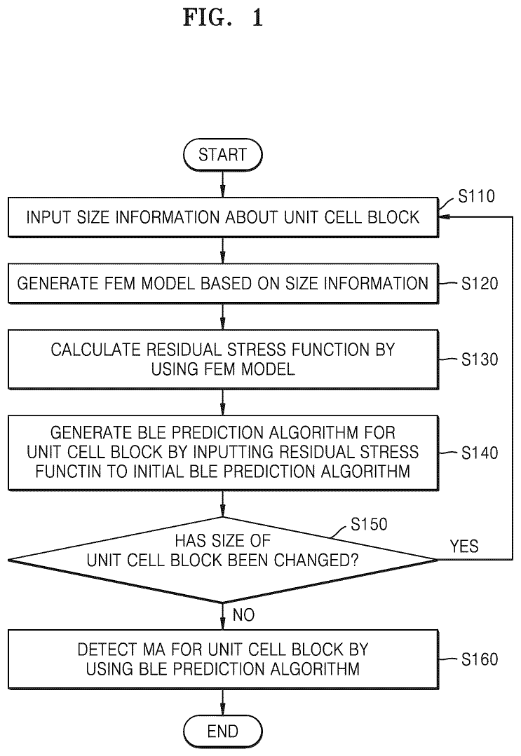

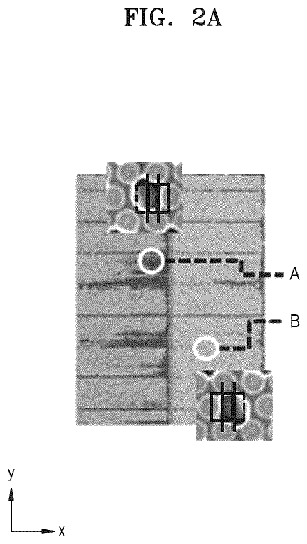

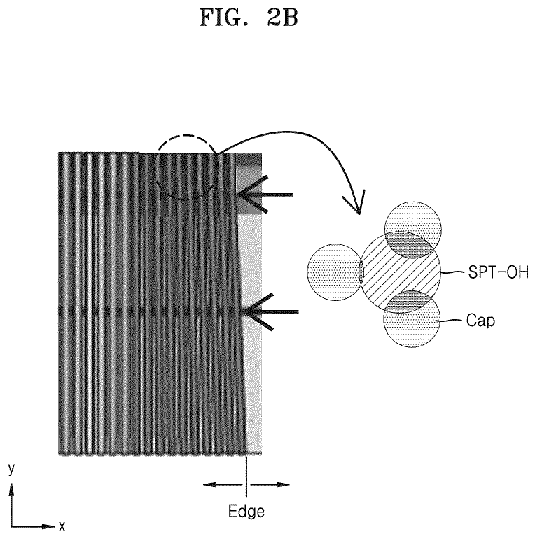

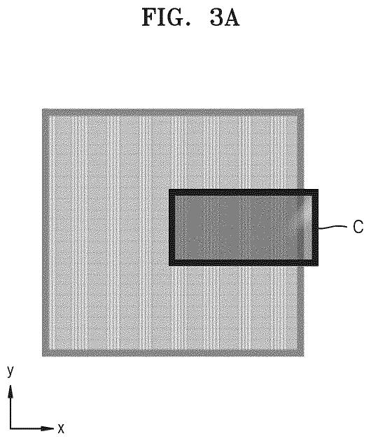

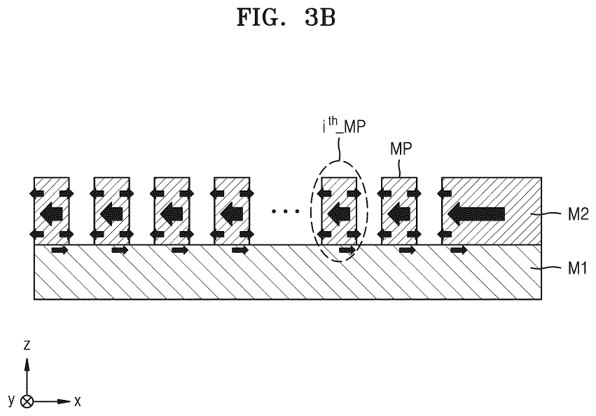

FIG. 1 is a schematic flowchart of a process of a mis-alignment detection method for a semiconductor device, according to various example embodiments, FIGS. 2A and 2B are cross-sectional views of an SEM photo and a portion of the SEM photo for explaining an issue of inclination of capacitors in a cell block of a dynamic random access memory (DRAM) device, respectively, and FIG. 2B is a cross-sectional view corresponding to region A in FIG. 2A.

Referring to FIG. 1, in a mis-alignment (MA) detection method (hereinafter, simply referred to as an ‘MA detection method’) for a semiconductor device according to the inventive concepts, firstly, size information for a unit cell block of a semiconductor device may be input (S110). In this case, the semiconductor device may include a DRAM device. However, the semiconductor device is not limited to a DRAM device. In addition, a unit cell block may mean one cell block when a cell region of a semiconductor device is divided into a plurality of blocks. On the other hand, the unit cell block may be largely divided into a main cell block and a modified cell block. In the case of the main cell block, the main cell block may have a standardized size, and may be repeatedly arranged in a two-dimensional array structure in a cell region. On the other hand, the modified cell block may not have a standardized size but may have various sizes, and may be arranged at particular locations in the cell region. In some example embodiments, the modified cell block may be referred to as a deformed capacitor (DCAP) cell block. Size information about the unit cell block may include a length in the x direction and a length in the y direction of the unit cell block on an x-y plane.

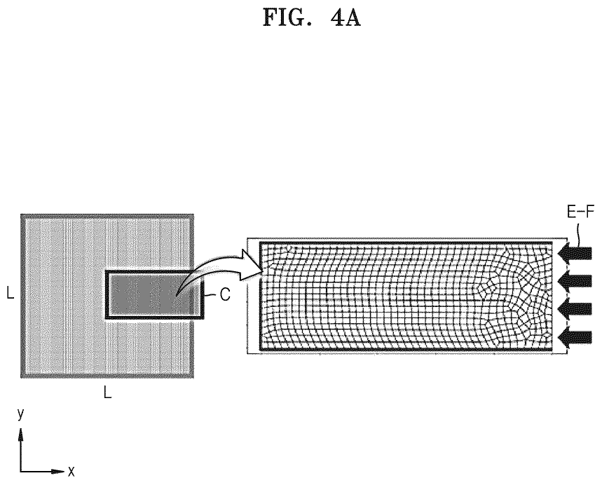

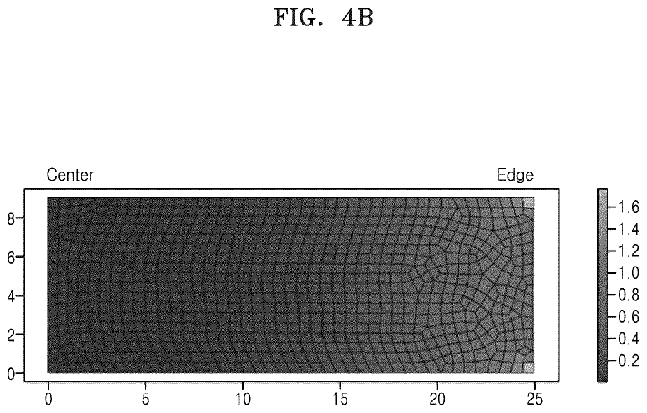

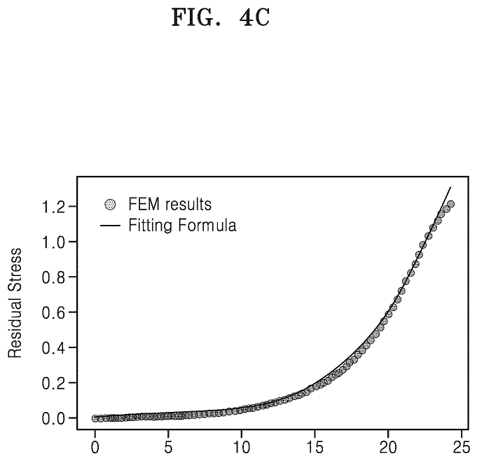

After the size information is input, a finite element method (FEM) model may be generated based on the size information (S120). The FEM may be the most widely used numerical analysis method in a structural analysis, a fluid analysis, a thermal analysis, a magnetic field analysis, or the like, and may be a method of dividing the analysis target into finite number of regions (elements), determining the contact points representing each region, and solving a governing equation of the contact points by approximating a system of linear equations. Software that automatically performs element division may be referred to as a pre-processor, software that solves a system of linear equations may be referred to as a solver, and software that presents the analysis results as graphics may be referred to as a post-processor. In the MA detection method of various example embodiments, when the size information for the unit cell block is input, a thermal-mechanical analysis based on stress may be performed on the unit cell block by using the FEM. The analysis by using the FEM may be performed automatically by using the pre-processor and the solver, and in addition, the analysis result may also be represented in graphics by using the post-processor. As a result, the FEM model may mean a model describing the unit cell block based on the thermal-mechanical analysis by using the FEM. The generation of the FEM model is described in more detail in the descriptions to be given with reference to FIGS. 4A through 4C.

After the FEM model is generated, a residual stress function may be calculated by using the FEM model (S130). The residual stress function may be calculated by applying a high-order polynomial fitting method to the FEM model. The calculation of the residual stress function is also described in more detail in the description with reference to FIGS. 4A through 4C.

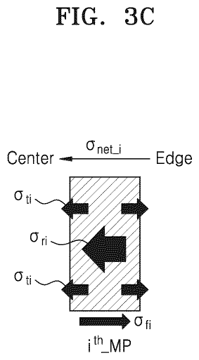

Thereafter, by inputting the residual stress function to an initial bulk layer effect (BLE) prediction algorithm, the BLE prediction algorithm for the unit cell block may be generated (S140). BLE may mean a phenomenon in which a mold pattern used to form a capacitor of a semiconductor device, such as a DRAM device, is bent toward the center of the unit cell block due to stress. In addition, the BLE prediction algorithm may mean an algorithm for predicting the MA of a capacitor within the unit cell block. A process of generating the BLE prediction algorithm is described in more detail in the descriptions with reference to FIGS. 3A through 3C.

On the other hand, the initial BLE prediction algorithm may, as the BLE prediction algorithm generated by using the main cell block, be calculated by using a fitting based on measured values. The process of generating the initial BLE prediction algorithm may be substantially the same as the BLE prediction algorithm. However, in the case of the BLE prediction algorithm because the constants obtained by using the measured values in the initial BLE prediction algorithm are used as they are, a separate measurement process may be unnecessary.

Referring to FIGS. 2A and 2B, to describe the BLE in more details, in FIG. 2A, both portions may correspond to the unit cell blocks with respect to a line extending in the y direction from the center in the x direction. In addition, enlarged SEM photos of regions A and B marked with white circles are illustrated adjacent to the regions A and B, and may have a shape in which large circles at the centers are surrounded by small circles. The large circle at the center may correspond to a support SPT open hole of a capacitor, and small circles may correspond to capacitors. On the other hand, in the SEM photo, the solid line portions may indicate the positions where the support SPT open holes are supposed to located, and the dashed line portions may indicate the moved positions as the capacitors are bent. As a result, in FIG. 2A, it may be understood that capacitors or SPT open holes are inclined toward the center from the boundaries between the unit cell blocks, that is, the edges of the unit cell blocks.

This issue may be clearly understood by using the cross-sectional view of FIG. 2B. In FIG. 2B, it may be identified that the capacitors Cap are inclined toward the center from the edge. On the other hand, on the right side of FIG. 2B, upper portions of the capacitors Cap are enlarged and illustrated in a plan view, and the hatched large circle may correspond to the support open hole (SPT-OH) at the original location. For reference, the support SPT may mean a support layer connecting the capacitors Cap to each other so that the capacitors Cap do not collapse, and as indicated by large arrows in FIG. 2B, two supports SPT may be arranged at the center location and at an upper location in a vertical direction, that is, in the z-direction. However, the number of supports SPT is not limited to two. For example, according to some example embodiments, one or three supports SPT may be arranged. On the other hand, when a mold layer for forming the capacitors Cap includes an oxide layer, the support SPT may include a nitride layer or an undoped polysilicon layer.

On the other hand, the support open hole SPT-OH may, as a through hole formed in the support SPT, remove the mold layer arranged under the support SPT by using the support open hole SPT-OH. As illustrated on the right side of FIG. 2B, when the support open hole SPT-OH is formed at the original location, as the capacitors Cap are bent, the support open hole SPT-OH may not be formed at an equivalent location between the capacitors Cap, but may be formed by a bias. Accordingly, a not-open (NOP) defect of the support SPT may occur. In this case, the NOP of the support SPT may mean a state in which the support open hole SPT-OH is not normally formed in the support SPT. The NOP of the support SPT may correspond to a major defect factor causing insufficient removal of the mold layer under the support SPT and thereby reducing the yield of DRAM devices.

Accordingly, by moving the support open hole SPT-OH located on the outer portion, that is, adjacent to the edge, toward the center within the unit cell block to reduce the occurrence of defects caused by the BLE, the MA of the support open hole SPT-OH may be corrected. In this case, the MA of the support open hole SPT-OH may correspond to the degree of mis-alignment occurring when the support open hole SPT-OH is formed at its original location, despite the location movement due to the bending of the capacitors Cap. In addition, the MA of the support open hole SPT-OH may be substantially the same as the degree of mis-alignment between the original location of the capacitors Cap when there is no bending and the moved location of the capacitors Cap when inclined. Accordingly, hereinafter, the MA of the support open hole SPT-OH and the MA of the capacitor may have substantially the same meaning.

Referring to FIG. 1 again, after the BLE prediction algorithm is generated, whether the size of the unit cell block has been changed may be determined (S150). When the size of the unit cell block is changed (YES), operation S110 of inputting the size information about the unit cell block may be performed. Thereafter, operations following operation S110 may be performed based on the newly input size for the unit cell block.

When the size of the unit cell block is not changed (NO), the MA for the unit cell block may be detected by using the BLE prediction algorithm (S160). In this case, the detection of the MA for the unit cell block may mean calculation and prediction of the MA by using the BLE prediction algorithm. In addition, the MA for the unit cell block may correspond to the MA of the capacitor Cap or the MA of the support open hole SPT-OH.

The MA detection method of various example embodiments may generate a FEM model that thermally-mechanically analyzes the BLE generation mechanism caused by mold thermal expansion based on the size information about the unit cell block, calculate a residual stress distribution in the mold by using the FEM model, and apply the residual stress distribution to generate a BLE model that predicts the MA in the unit cell block. The MA detection method of the various example embodiments may, by detecting the MA in the unit cell block by using the BLE model generated in this manner, overcome the limitations of general gradual pattern shift (GPS) technology, and accurately detect the MA in various types of unit cell blocks. In addition, by reflecting and correcting the detected MA in the mask, the NOP defect of the support SPT caused by the BLE in a DRAM device may be improved.

For reference, the GPS technology may mean a technology that corrects the mask based on the MA and moves the support open hole SPT-OH toward the center within the unit cell block. In the general GPS technology, MA values of the capacitor Cap or the support open hole SPT-OH within the unit cell block may be measured by using the SEM, or the like, and the MA may be predicted by using a linear fitting to correct the mask. However, in the case of the general GPS technology, manufacturing an additional mask to measure a plurality of MA values within the unit cell block may be required, and there is an issue that an additional process cost is required. In addition, because linear fitting may be used based on measurement data, an issue in prediction accuracy may also occur. On the other hand, as the generation of DRAM product development has passed, the sizes of unit cell blocks have been diversified, and in particular, in the case of the modified cell block, the types of sizes of modified cell blocks are increasing to thousands or more. Accordingly, measuring all MAs for each type to predict the MAs of the capacitors Cap of the unit cell blocks may be limited in terms of time and cost.

However, the MA detection method in various example embodiments may solve all the issues in the general GPS technology, by detecting the MA in the unit cell block by using the FEM model, the residual stress distribution calculation, and the BLE model generation.

FIGS. 3A through 3C are a plan view and cross-sectional views of the unit cell block for explaining a reason of inclination of capacitors in a cell block of a DRAM device, respectively, FIG. 3B is a cross-sectional view of portion C in FIG. 3A, and FIG. 3C is an enlarged cross-sectional view of one of mold patterns in FIG. 3B. Duplicate descriptions already given with reference to FIGS. 1 through 2B are briefly described or omitted.

Referring to FIGS. 3A through 3C, FIGS. 3A and 3B illustrate mold patterns MP for forming capacitors Cap before forming the capacitors Cap, and the mold patterns MP may be formed on a first mold layer M1 and may be formed by patterning a second mold layer M2. The capacitor Cap may be formed by filling a space between the mold patterns MP with a conductive layer and a dielectric layer. The first mold layer M1 and the second mold layer M2 may include different materials. However, in some example embodiments, the first mold layer M1 and the second mold layer M2 may also include substantially the same material.

In the MA detection method according to various example embodiments, the second mold layer M2 and the mold pattern MP may include an oxide layer. For example, the second mold layer M2 and the mold pattern MP may include an oxide layer, such as boro phosphorous silicate glass (BPSG), spin on die electric (SOD), phosphorous silicate glass (PSG), low pressure tetra ethyl ortho silicate (LPTEOS), and plasma enhanced tetra ethyl ortho silicate (PETEOS). However, the materials of the second mold layer M2 and the mold pattern MP are not limited to the aforementioned materials.

Various types of stresses as represented by the arrows may be applied to the mold pattern MP. FIG. 3C illustrates an i^{th} (i is a natural number) mold pattern i^{th}_MP in FIG. 3B, and particular types of stresses applied to the i^{th} mold pattern i^{th}_MP are represented as arrows of various sizes. A thin and long arrow at the top may represent the net stress: σ_{net_i} of the i^{th} mold pattern i^{th}_MP, the thickest arrow may represent the residual stress σᵣᵢ of the i^{th} mold pattern i^{th}_MP, two medium-thick arrows over and below the residual stress σᵣᵢ arrow may represent a thermal stress σₜᵢ of the i^{th} mold pattern i^{th}_MP, and the long medium-thick arrow at the bottom may represent a frictional stress σ_{fi} of the i^{th} mold pattern i^{th}_MP. The net stress σ_{net_i} for the i^{th} mold pattern (i^{th}_MP) may be represented by Equation 1 below.

σ_{net_i}=σᵣᵢ+σₜᵢ+σ_{fi} Equation 1

For reference, the residual stress σᵣᵢ may be a stress accumulated in the i^{th} mold pattern i^{th}_MP by previous processes, the thermal stress σₜᵢ may be a stress caused by thermal expansion of the i^{th} mold pattern i^{th}_MP, and the frictional stress of is a stress caused by interface resistance between the mold layers. For example, the frictional stress σ_{fi} may be a stress caused by the interface resistance between the first mold layer M1 and the second mold layer M2 of the i^{th} mold pattern i^{th}_MP. In addition, the frictional stress of may also occur due to the interface resistance with respect to an upper mold layer, when there is another mold layer on the i^{th} mold pattern i^{th}_MP.

The thermal stress σₜᵢ may be expressed as EαΔT, by using a temperature rise (ΔT). In this case, E may be a Young's modulus of the mold pattern MP, that is, the material of the second mold layer M2, and α may be a coefficient of thermal expansion. In addition, when thermal expansion occurs due to temperature rise, the frictional stress of may usually converge to about 0.

On the other hand, the net stress σ_{net_i} for the i^{th} mold pattern i^{th}_MP may also be expressed as Equation 2 below according to the Hook Law.

σ_{net_i}=Eεᵢ Equation 2

In Equation 2, εᵢ may be a linear expansion ratio, expressed as ΔLᵢ/Lᵢ. In addition, Li may be a length of the i^{th} mold pattern i^{th}_MP in the x direction, and ΔLᵢ may correspond to BLEi, as modification in a length direction of the i^{th} mold pattern i^{th}_MP. In this case, the length direction may be the x direction.

Accordingly, Equation 2 may be modified to σ_{net_i}=E*ΔLᵢ/Lᵢ=E*BLEi/Lᵢ. In addition, when σ_{fi} is set to about 0 in Equation 1, and EαΔT is substituted for σₜᵢ and combined with the modified Equation 2, the result thereof may become that σᵣᵢ+EαΔT=E*BLEi/Li, and BLEi may be expressed as Equation 3 below.

BLEi=Lᵢ/E(σᵣᵢ+EαΔT) Equation 3

Lᵢ, E, and EαΔT may be constant values determined by the material of the i^{th} mold pattern i^{th}_MP, that is, the second mold layer M2, and may be obtained by performing measurement. For example, when the initial BLE prediction algorithm in the MA detection method of various example embodiments is generated, values of Lᵢ, E, and EαΔT may be obtained by using the main cell block to perform measurement and fittings. Thereafter, when the BLE prediction algorithm for another unit cell block is generated, and the material of the second mold layer M2 is the same, the values obtained during the generation of the initial BLE prediction algorithm may be used as they are.

On the other hand, the residual stress σᵣᵢ may be calculated by using the FEM model, and as described above, when the size information about the unit cell block is input, the residual stress σᵣᵢ may be automatically calculated. A method of calculating the residual stress σᵣᵢ by using the FEM model is described in more detail in descriptions to be given with reference to FIGS. 4A through 4C.

FIGS. 4A through 4C may be conceptual diagrams for explaining an operation of generating the FEM model and an operation of calculating a residual stress function, in the MA detection method of FIG. 1. The contents already described in the descriptions given with reference to FIGS. 1 through 3C are briefly described or omitted.

Referring to FIGS. 4A through 4C, portion C of the unit cell block on the left side in FIG. 4A may be expressed as illustrated on the right side by using a mesh model. The unit cell block in FIG. 4A may have a square shape in a plan view. For example, the unit cell block may have a length L in each of the x direction and the y direction. In addition, the portion C of the unit cell block may have a rectangular shape extending from the edge portion toward the center, and the mesh model may also have a rectangular shape corresponding thereto.

As described above, because the residual stress σᵣᵢ in the unit cell block is applied from the boundary between the unit cell blocks, that is, the edge of the unit cell block toward the center thereof, it may be assumed that an external force E-F is applied only to the right side in the rectangular mesh model, as represented by the arrows. Accordingly, the conditions of the FEM model may be configured to accumulate residual stress σᵣᵢ from the edge to the center of a rectangle by fixing an upper side, a lower side, and a left side of the rectangle, and applying an external force from the right side of the rectangle. The fixing of the upper side, the lower side, and the left side of the rectangle may be a boundary condition, and may correspond to a constraint of the FEM model.

FIG. 4B illustrates the analysis result by using the FEM, that is, the FEM model in graphics. In FIG. 4B, the x-axis and y-axis may represent locations, the units thereof may be arbitrary units, and the residual stress σᵣᵢ may be expressed as light and shade of black and white colors. Referring to FIG. 4B, it may be seen that the residual stress σᵣᵢ is large on the edge side and the residual stress σᵣᵢ is released toward the center. On the other hand, the FEM model may be generated by using, for example, an updated Lagrangian-based finite element analysis simulation.

FIG. 4C illustrates the plane residual stress σᵣᵢ by using the FEM model of FIG. 4B as a linear residual stress σᵣᵢ function by calculating the plane residual stress σᵣᵢ in an axis of the unit cell block, for example, the x axis. In the graph of FIG. 4C, the x-axis may correspond to the x-axis in FIG. 4B, the unit thereof may be an arbitrary unit, the y-axis may represent the residual stress σᵣᵢ, and the unit thereof may also be an arbitrary unit. On the other hand, the linear residual stress σᵣᵢ by using the FEM model may be represented by multiple points, and the linear residual stress σᵣᵢ function with respect to the x-axis may be calculated by performing a fitting such as a high-order polynomial fitting on the multiple points.

For example, in the MA detection method according to various example embodiments, when the size of the length L of the unit cell block is about 48 μm, the linear residual stress σᵣᵢ function may be calculated as σᵣᵢ=6.6x⁴−29.9x³−1126.5x²+11167x−13737 with respect to the x-axis. In addition, when the linear residual stress σᵣᵢ function is substituted into Equation 3 described above, the resultant Equation of the BLEi prediction algorithm may be obtained as Equation 4 below.

BLEi=Lᵢ/E{(6.6x⁴−29.9x³−1126.5x²+11167x−13737)+EαΔT} Equation 4

Accordingly, by substituting the location value in the x direction within the unit cell block into Equation 4, the BLEi at that location, that is, the MA of the capacitor Cap or the support open hole SPT-OH may be numerically calculated. The results may be identically derived with respect to the y direction in the unit cell block by using the processes described above with reference to FIGS. 4A through 4C.

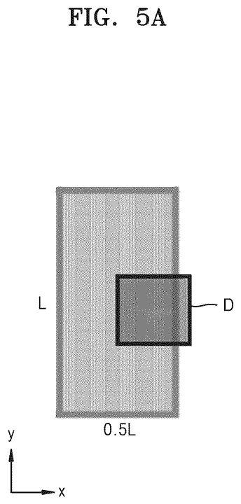

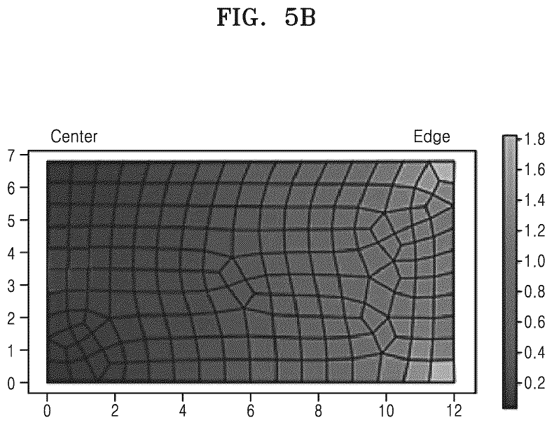

FIGS. 5A and 5B are conceptual diagrams of an FEM model for unit cell blocks of different shapes. The contents already described in the descriptions given with reference to FIGS. 1 through 4C are briefly described or omitted.

Referring to FIGS. 5A and 5B, FIG. 5A illustrates a unit cell block, and FIG. 5B illustrates an analysis result by using the FEM, that is, the FEM model, in graphics. The unit cell block in FIG. 5A may have a rectangular shape in a plan view. For example, the unit cell block of FIG. 5A may have a length of about 0.5 times the length L in the x direction and a length of the length L in the y direction. In addition, portion D of the unit cell block may have a rectangular shape extending from the edge portion toward the center. In the FEM model of FIG. 5B, the x-axis and y-axis may represent locations, the units thereof may be arbitrary units, and the residual stress σᵣᵢ may be expressed as light and shade of black and white colors. Referring to FIG. 5B, it may be seen that the residual stress σᵣᵢ is large on the edge side and the residual stress on is released toward the center.

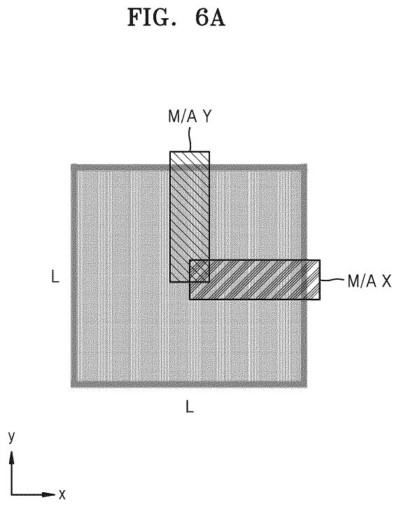

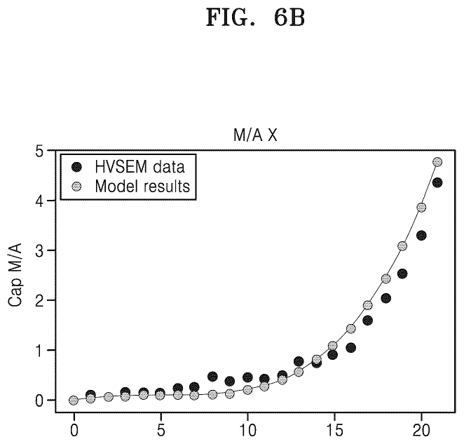

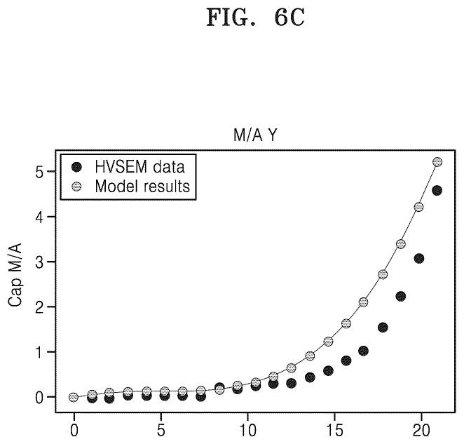

FIGS. 6A through 6C are a plan view of main cell blocks and graphs of the MA of a capacitor detected by the MA detection method of the inventive concepts compared with data measured by the SEM, respectively. In the graphs of FIG. 6B and FIG. 6C, the x-axis may represent locations in the x direction and the y direction, respectively, the unit in the x-axis may be an arbitrary unit, the y-axis may be the MA of a capacitor, and the unit in the y-axis may be an arbitrary unit. In addition, in the graphs of FIGS. 6B and 6C, gray points of Model results may be the MA of the capacitor detected by using the MA detection method of various example embodiments, and black points of HVSEM data may represent data measured by using the SEM. For reference, “HV” in the HVSEM may mean “high voltage”. The contents already given with reference to FIGS. 1 through 5B are briefly described or omitted.

Referring to FIGS. 6A through 6C, the unit cell block of FIG. 6A may be a main cell block, and may have a square shape in a plan view. For example, the main cell block of FIG. 6A may have a length of the length L in the x direction and a length of the length L in the y direction. In addition, each of portion M/A X and portion M/A Y of the main cell block may have a rectangular shape extending from the edge portion toward the center of each of the portions.

FIG. 6B illustrates the MA of the capacitor in the x direction detected by using the MA detection method of the various example embodiments and data measured by using the SEM, with respect to a portion corresponding to the portion M/A X in FIG. 6A. In addition, FIG. 6C illustrates the MA of the capacitor in the y direction detected by using the MA detection method of the various example embodiments and data measured by using the SEM, with respect to a portion corresponding to the portion M/A Y in FIG. 6A.

Referring to the graphs of FIGS. 6B and 6C, it may be identified that the MA of the capacitor detected by using the MA detection method of the various example embodiments and the MA of the capacitor measured by using the SEM are similar to each other, in the portions M/A X and M/A Y of the main cell block. As a result, the MA of the capacitor may be accurately detected by using the MA detection method of the various example embodiments.

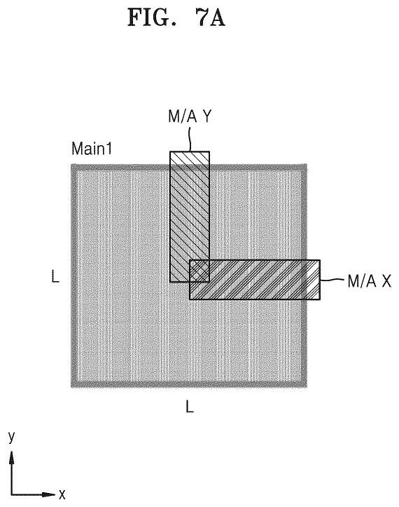

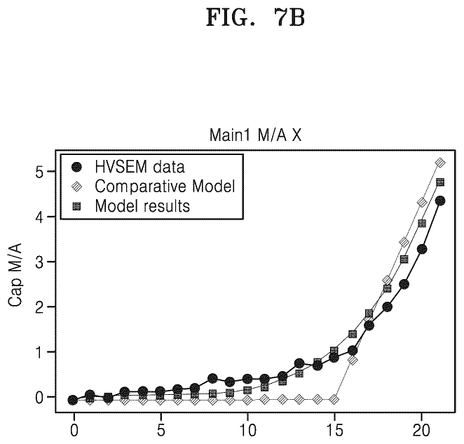

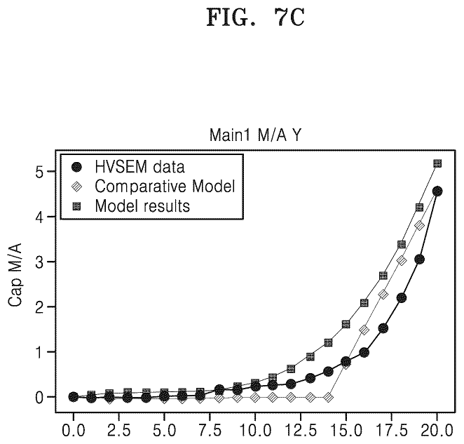

FIGS. 7A through 12C illustrate plan views of various types of unit cell blocks, and graphs of comparing the MA of a capacitor detected by using the MA detection method of a comparison example, the MA of a capacitor detected by using the MA detection method of the various example embodiments, and data measured by using the SEM, corresponding to the plan views. In the graphs of FIGS. 7B, 7C, 8B, 8C, 9B, 9C, 10C, 11B, 11C, 12B, and 12C, the x-axis may represent locations in the x direction and the y direction, a unit in the x-axis may be an arbitrary unit, and the y-axis may be the MA of the capacitor and a unit of the y-axis may be an arbitrary unit. In addition, in the graphs of FIGS. 7B, 7C, 8B, 8C, 9B, 9C, 10B, 10C, 11B, 11C, 12B, and 12C, the model results of black squares may represent the MA of the capacitor detected by the MA detection method of various example embodiments, the HVSEM data of black dots may represent data measured by using the SEM, and the complementive model of gray rhombuses may represent the MA of the capacitor detected by using the MA detection method of a comparison example. The contents already given with reference to FIGS. 1 through 6C are briefly described or omitted.

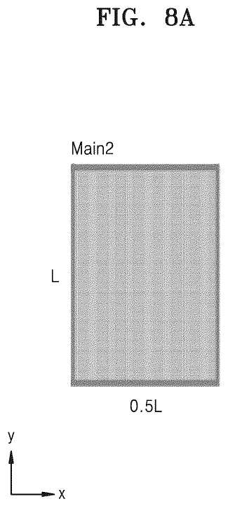

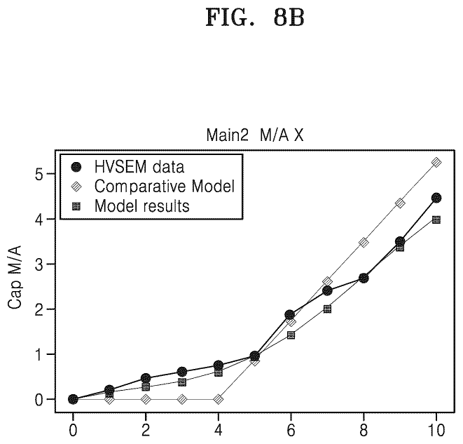

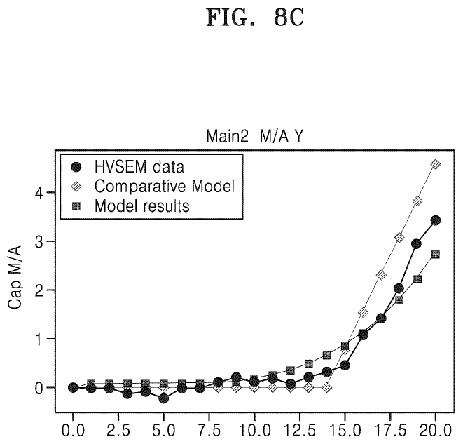

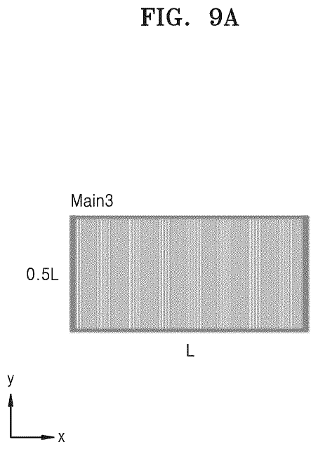

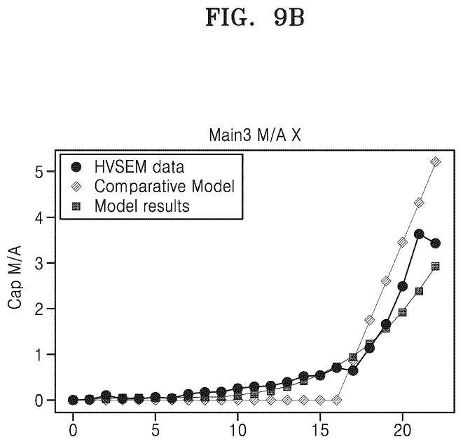

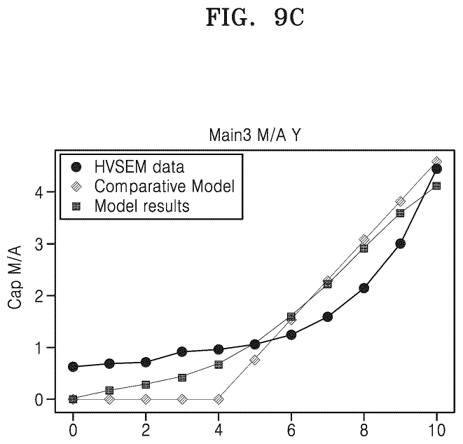

Referring to FIGS. 7A through 12C, the unit cell blocks of FIGS. 7A, 8A, and 9A may include first through third main cell blocks Main1 through Main3, and may have a square, a rectangle elongated in the y direction, or a rectangle elongated in the x direction. For example, the first main cell block Main1 of FIG. 7A may have a length of the length L in the x direction and a length of the length L in the y direction, and may be substantially the same as the main cell block of FIG. 6A. In addition, the second main cell block Main2 of FIG. 8A may have a length of about 0.5 times the length L in the x direction and a length of the length L in the y direction, and the third main cell block Main3 of FIG. 9A may have a length of the length L in the x direction and a length of about 0.5 times the length L in the y direction. In this manner, in the case of the first through third main cell blocks Main1 through Main3, they may have somewhat standardized sizes in the x direction and the y direction.

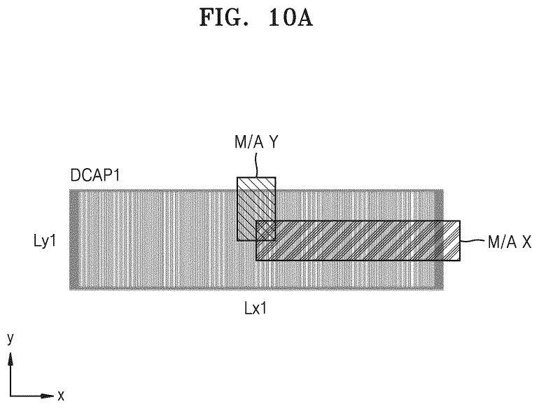

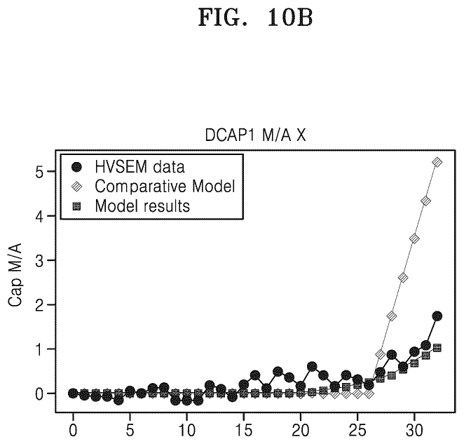

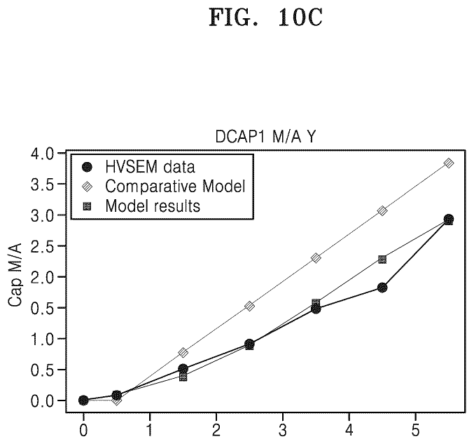

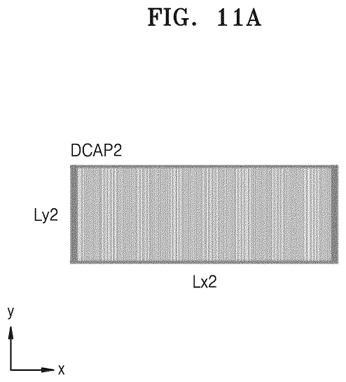

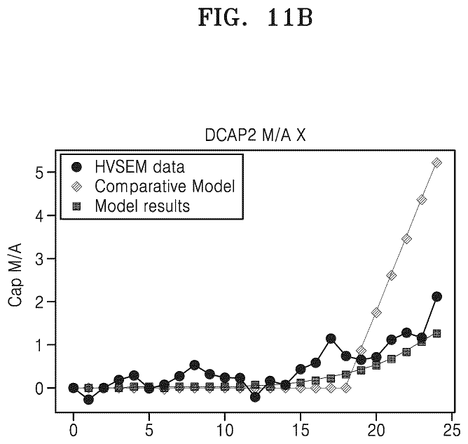

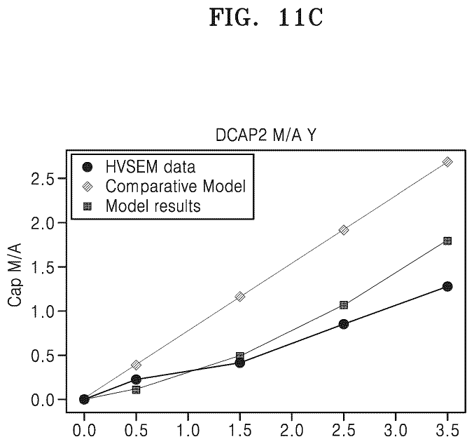

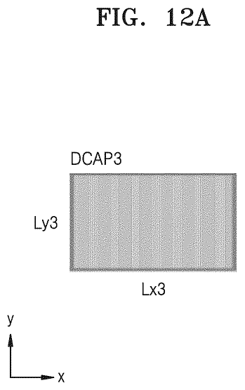

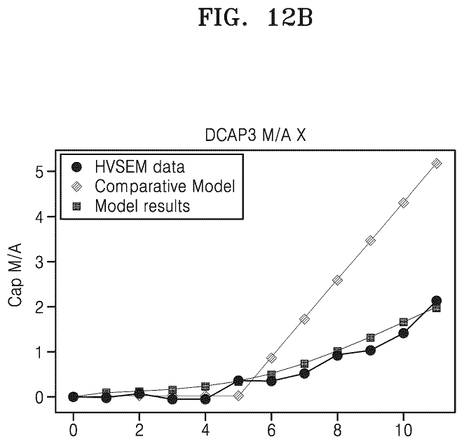

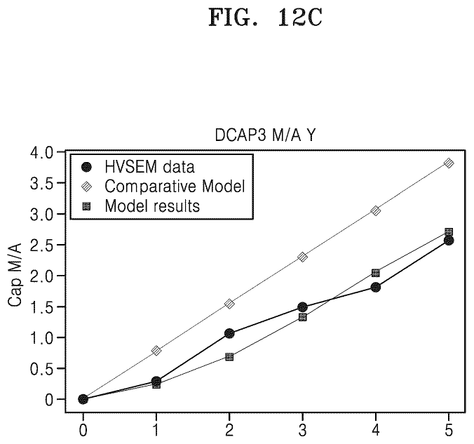

On the other hand, unit cell blocks of FIGS. 10A, 11A, and 12A may include first through third modified cell blocks DCAP1, DCAP2, and DCAP3, and may have a rectangular shape elongated in the x direction. For example, the first modified cell block DCAP1 in FIG. 10A may have a length of Lx1 in the x direction and a length of Ly1 in the y direction, the second modified cell block DCAP2 in FIG. 11A may have a length of Lx2 in the x direction and a length of Ly2 in the y direction, and the third modified cell block DCAP3 in FIG. 12A may have a length of Lx3 in the x direction and a length of Ly3 in the y direction. In this manner, in the case of the first through third modified cell blocks DCAP1, DCAP2, and DCAP3, the sizes of the first through third modified cell blocks DCAP1, DCAP2, and DCAP3 may not be standardized in the x direction and the y direction, and may vary. In addition, the modified cell block may have a rectangular shape elongated in the x direction as well as a rectangular shape elongated in the y direction.

FIGS. 7B, 8B, 9B, 10B, 11B, and 12B may illustrate the MA of a capacitor in the x direction detected by using the MA detection method of various example embodiments, the MA of a capacitor in the x direction detected by using the detection method of a comparison example, and data measured by using the SEM. In addition, FIGS. 7C, 8C, 9C, 10C, 11C, and 12C may illustrate the MA of a capacitor in the y direction detected by using the MA detection method of various example embodiments, the MA of a capacitor in the y direction detected by using the detection method of a comparison example, and data measured by using the SEM.

Referring to the graphs of FIGS. 7B, 7C, 8B, 8C, 9B, and 9C, it may be understood that, in the portions M/A X and M/A Y of the first through third main cell blocks Main1 through Main3, the MA of a capacitor detected by using the MA detection method of various example embodiments is substantially similar to the data measured by using the SEM. On the other hand, in the case of the MA of a capacitor detected by using the MA detection method of the comparison example, based on a linear fitting method, the MA may appear about 0 from the center to a certain region, and thereafter, appear as a first-order linear graph from the certain region to the edge. Accordingly, it may be understood that there is a lot of difference between the MA of a capacitor detected by using the MA detection method of a comparison example and the data measured by using the SEM.

For reference, the data measured by using the SEM may correspond to an actual MA of a capacitor. Accordingly, when the degree of improvement in the first through third main cell blocks Main1 through Main3 is calculated in detailed values, the MA of the capacitor detected by using the MA detection method of various example embodiments may have an average error of about 0.29 compared to the data measured by using the SEM, while the MA of the capacitor detected by using the MA detection method of the comparison example may have an average error of about 0.41 compared to the data measured by using the SEM. Thus, it may be identified that the MA detection method of various example embodiments has improved accuracy by about 28.58% compared to the MA detection method of the comparison example.

On the other hand, referring to the graphs of FIGS. 10B, 10C, 11B, 11C, 12B, and 12C, it may be understood that, in the portions M/A X and M/A Y of the first through third modified cell blocks DCAP1, DCAP2, and DCAP3, the MA of a capacitor detected by using the MA detection method of the various example embodiments is substantially similar to the data measured by using the SEM. On the other hand, in the case of the MA of a capacitor detected by using the MA detection method of the comparison example, in the portion M/A X, based on a linear fitting method, the MA may appear about 0 from the center to a certain region, and thereafter, appear as a first-order linear graph from the certain region to the edge. In addition, it may be identified that the MA of the first-order linear graph portion differs severely from the data measured by using the SEM. On the other hand, the MA of the capacitor in the portion M/A Y may appear as a nearly first-order linear graph from the center to the edge, and it may be identified that the MA of the capacitor in the portion M/A Y is significantly different from the data measured by SEM.

Accordingly, when the degree of improvement in the first through third modified cell blocks DCAP1, DCAP2, and DCAP3 is calculated in detailed values, the MA of the capacitor detected by using the MA detection method of various example embodiments may have an average error of about 0.45 compared to the data measured by using the SEM, while the MA of the capacitor detected by using the MA detection method of the comparison example may have an average error of about 1.02 compared to the data measured by using the SEM. Thus, it may be identified that the MA detection method of various example embodiments has improved accuracy by about 56.48% compared to the MA detection method of the comparison example.

In conclusion, it may be identified that the accuracy of the MA of the capacitor obtained by using the MA detection method of various example embodiments is significantly improved compared to the accuracy of the MA of the capacitor obtained by using the MA detection method of the comparison example. In addition, it may be identified that the accuracy of MA is improved more significantly in the modified cell block.

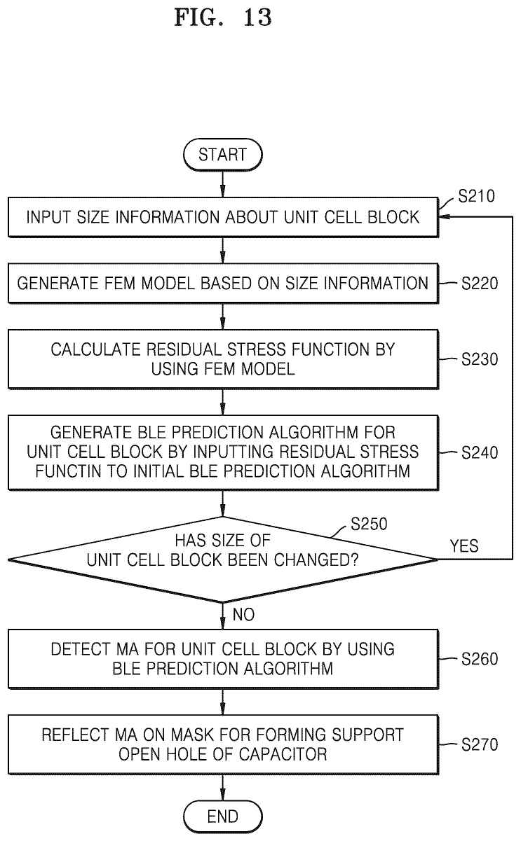

FIG. 13 is a schematic flowchart of processes of a semiconductor element manufacturing method according to various example embodiments. Descriptions are given with reference to FIGS. 1 through 2B together, and duplicate descriptions already given with reference to FIGS. 1 through 12C are briefly given or omitted.

Referring to FIG. 13, the semiconductor device manufacturing method according to various example embodiments sequentially performs operation S210 of inputting size information about the unit cell block through operation S260 of detecting the MA for the unit cell block by using the BLE prediction algorithm. The operation S210 of inputting size information about the unit cell block through operation S260 of detecting the MA for the unit cell block by using the BLE prediction algorithm in FIG. 13 may be substantially the same as the operation S110 of inputting size information about the unit cell block through operation S160 of detecting the MA for the unit cell block by using the BLE prediction algorithm in FIG. 1, respectively. Thus, detailed descriptions thereof are omitted.

After the MA of the unit cell block is detected, the MA may be reflected on a mask for forming the support open hole SPT-OH of a capacitor (S270). In this case, the reflecting of the MA on the mask may mean changing a position of a pattern of the mask for forming the support open hole SPT-OH. In a DARM device, the support SPT may mean a support layer which connects the capacitors Cap to each other so that the capacitors Cap do not collapse. In addition, the support open hole SPT-OH may include a through hole formed in the support to remove the mold layer under the support SPT. To form the support open hole SPT-OH as described above, firstly, a pattern corresponding to the support open hole SPT-OH may be formed on the mask. Next, an exposure process using the mask may be performed to form the support open hole SPT-OH in the support SPT.

On the other hand, when the MA of the capacitor Cap is generated due to the bending of the mold pattern, and thus, when the support open hole SPT-OH is formed at the original location, the support open hole SPT-OH may not formed at an equivalent location between the capacitors Cap, but may be formed at a skewed location significantly overlapping the capacitors Cap. As a result, an NOP defect of the support SPT may occur, the mold layer under the support SPT may be insufficiently removed due to the NOP defect of the support SPT, and thus, the yield of a DRAM device may be reduced. Accordingly, it may be necessary to change the location of the support open hole SPT-OH corresponding to the MA of the capacitor Cap. Thus, in operation S270 of reflecting the MA on the mask for forming the support open hole SPT-OH of the capacitor, by changing the location of the pattern of the mask used for forming the support open hole SPT-OH, the location of the support open hole SPT-OH may be changed to correspond to the MA of the capacitor Cap. As a result, in the semiconductor device manufacturing method of various example embodiments, by accurately detecting the MA of the capacitor by using the MA detection method in FIG. 1 described above, and reflecting the detected MA on the mask to form the support open hole SPT-OH, the NOP defect of the support SPT may be solved, and accordingly, the yield of a DRAM device may be improved.

In addition, in the semiconductor device manufacturing method of various example embodiments, a semiconductor device, such as a DRAM device, may be completed by performing various subsequent semiconductor processes after operation S270 of reflecting the MA on the mask for forming the support open hole SPT-OH of the capacitor. In this case, the subsequent semiconductor processes may include various processes. For example, the subsequent semiconductor processes may include an exposure process, a deposition process, an etching process, an ion process, a cleaning process, etc. In addition, the subsequent semiconductor processes may include a test process for semiconductor devices. Furthermore, the subsequent semiconductor processes may include a process of individualizing a wafer into semiconductor chips. In some example embodiments, the subsequent semiconductor processes may also include a process of packaging a semiconductor chip. The packaging process may mean a process of mounting a semiconductor chip on a printed circuit board (PCB) and sealing the semiconductor chip with a sealing material, and may include stacking multiple semiconductor chips in multiple layers on the PCB to form a stacked package, or stacking a stacked package on the stacked package to form a package on package (POP) structure.

While the inventive concepts has been particularly shown and described with reference various example embodiments thereof, it will be understood that various change in form and details may be made therein without departing from the spirit and scope of the following claims.

What is claimed is:

1. A mis-alignment (MA) detection method for a semiconductor device, the MA detection method comprising:
inputting size information about a unit cell block of the semiconductor device;
generating a finite element method (FEM) model based on the size information;
calculating a residual stress function of the unit cell block using the FEM model;
generating a bulk layer effect (BLE) prediction algorithm for the unit cell block by inputting the residual stress function into an initial BLE prediction algorithm generated based on a main cell block of the semiconductor device; and
selectively detecting the MA of the unit cell block using the BLE prediction algorithm.

2. The MA detection method of claim 1, wherein
the semiconductor device comprises a dynamic random access memory (DRAM),
the BLE is a phenomenon in which a mold pattern used for forming a capacitor of the semiconductor device is bent toward a center of the unit cell block due to stress, and
the MA is an MA of the capacitor.

3. The MA detection method of claim 2, wherein
a net stress σₙₑₜ applied to the mold pattern is represented by Equation 1 below,
σₙₑₜ=σᵣ+σₜ+σ_{f} Equation 1,
wherein σᵣ is a residual stress accumulated in the mold pattern through previous processes, σₜ is thermal stress due to a thermal expansion of the mold pattern, and σ_{f} is frictional stress due to interface resistance between mold layers,
wherein σₜ is represented as EαΔT,
wherein E is a Young's modulus, a is a thermal expansion coefficient, and ΔT is a temperature rise, and
wherein, in response to the thermal expansion of the mold pattern occurring due to the temperature rise, σ_{f} converges towards 0.

4. The MA detection method of claim 3,
wherein, according to Hook's Law, the net stress σₙₑₜ is expressed as Equation 2 below,
σₙₑₜ=Eε Equation 2,
wherein ε is a linear expansion ratio represented as ΔL/L,
wherein ΔL is deformation in a length direction and corresponds to the BLE, and
wherein, based on the Equation 1 and Equation 2, the BLE is expressed in Equation 3 below,
BLE=L/E(σᵣ+EαΔT) Equation 3,
wherein L, E, and EαΔT are constant values defined by a material of the mold pattern, and
wherein the residual stress functions as a variable.

5. The MA detection method of claim 2,
wherein, in the calculating the residual stress function,
conditions for the FEM model are configured such that an upper side, a lower side, and a left side of a rectangle are fixed, and an external force is applied to a right side to accumulate the residual stress.

6. The MA detection method of claim 5, wherein, in the calculating the residual stress function of the unit cell block, results obtained by using the FEM model are calculated as the residual stress function by using a high-order polynomial fitting.

7. The MA detection method of claim 2, wherein, in the calculating the residual stress function of the unit cell block, the FEM model is generated by using an updated Lagrangian-based finite element analysis simulation.

8. The MA detection method of claim 2, wherein the MA is reflected in manufacturing a mask for forming a support open hole of the capacitor.

9. The MA detection method of claim 1, further comprising
after the generating of the BLE prediction algorithm,
determining whether a size of the unit cell block has been changed,
wherein, in response to the size of the unit cell block changing, the size information is input, and
wherein, in response to the size of the unit cell block having not been changed, the detecting the MA is performed.

10. The MA detection method of claim 1, wherein, in the detecting the MA, the MA in at least one region of a center region, an edge region, and a corner region of the unit cell block is detected.

11. A mis-alignment (MA) detection method for a semiconductor device, the MA detection method comprising:
inputting size information about a unit cell block to be calculated of a dynamic random access memory (DRAM) device;
generating a finite element method (FEM) model based on the size information;
calculating a residual stress function of the unit cell block by using the FEM model;
generating a bulk layer effect (BLE) prediction algorithm for the unit cell block by inputting the residual stress function to an initial BLE prediction algorithm generated based on a main cell block of the DRAM device;
determining whether a size of the unit cell block has been changed; and
by using the BLE prediction algorithm, selectively detecting the MA of a capacitor of the DRAM device in the unit cell block,
wherein the BLE is a phenomenon in which a mold pattern used for forming a capacitor of the semiconductor device is bent toward a center of the unit cell block due to stress,
wherein, in response to determining the size of the unit cell block has been changed, the size information is input, and
wherein, in response to determining the size of the unit cell block has not been changed, the detecting the MA is performed.

12. The MA detection method of claim 11,
wherein a net stress σₙₑₜ applied to the mold pattern is represented by Equation 1 below,
σₙₑₜ=σᵣ+σₜ+σ_{f} Equation 1,
wherein σᵣ is a residual stress accumulated in the mold pattern through previous processes, σₜ is thermal stress due to a thermal expansion of the mold pattern, and σ_{f} is frictional stress due to interface resistance between mold layers,
wherein σₜ is represented by EαΔT,
wherein E is a Young's modulus, α is a thermal expansion coefficient, and ΔT is a temperature rise, and
wherein, in response to the thermal expansion of the mold pattern occurring due to the temperature rise, σ_{f} converges towards 0.

13. The MA detection method of claim 12,
wherein, according to Hook's Law, the net stress σₙₑₜ is expressed as Equation 2 below,
σₙₑₜ=Eε Equation 2,
wherein ε is a linear expansion ratio represented as ΔL/L,
wherein ΔL is deformation in a length direction and corresponds to the BLE, and wherein, based on the Equation 1 and Equation 2, the BLE is expressed in Equation 3 below,
BLE=L/E(σᵣ+EαΔT) Equation 3,
wherein L, E, and EαΔT are constant values defined by a material of the mold pattern, and
wherein the residual stress functions as a variable.

14. The MA detection method of claim 11,
wherein, in the calculating the residual stress function,
conditions for the FEM model are configured such that an upper side, a lower side, and a left side of a rectangle are fixed, and an external force is applied to a right side to accumulate a residual stress, and
results obtained by using the FEM model is calculated as the residual stress function by using a high-order polynomial fitting.

15. A semiconductor device manufacturing method, the method comprising:
inputting size information about a unit cell block to be calculated of a semiconductor device;
generating a finite element method (FEM) model based on the size information;
calculating a residual stress function of the unit cell block by using the FEM model;
generating a bulk layer effect (BLE) prediction algorithm for the unit cell block by inputting the residual stress function to an initial BLE prediction algorithm generated based on a main cell block of the semiconductor device;
determining whether a size of the unit cell block has been changed;
selectively detecting mis-alignment (MA) of the unit cell block by using the BLE prediction algorithm; and
reflecting the MA on a mask for forming a pattern of the semiconductor device,
wherein, in response to determining the size of the unit cell block changing, the size information is input, and
wherein, in response to determining the size of the unit cell block having not been changed, the detecting the MA is performed.

16. The method of claim 15, wherein
the semiconductor device comprises a dynamic random access memory (DRAM) device,
wherein the BLE is a phenomenon in which a mold pattern used for forming a capacitor of the semiconductor device is bent toward a center of the unit cell block due to stress, and
wherein the MA is an MA of the capacitor.

17. The method of claim 16,
wherein a net stress σₙₑₜ applied to the mold pattern is represented by Equation 1 below,
σₙₑₜ=σᵣ+σₜ+σ_{f} Equation 1,
wherein σᵣ is a residual stress accumulated in the mold pattern through previous processes, σₜ is thermal stress due to a thermal expansion of the mold pattern, and σ_{f} is frictional stress due to interface resistance between mold layers,
wherein σₜ is represented by EαΔT, the E is a Young's modulus, α is a thermal expansion coefficient, and ΔT is a temperature rise, and
wherein, in response to a thermal expansion occurring due to the temperature rise, σ_{f} converges towards 0.

18. The method of claim 17, wherein,
according to Hook's Law, the net stress σₙₑₜ is expressed as Equation 2 below,
σₙₑₜ=Eε Equation 2,
wherein ε is a linear expansion ratio represented as ΔL/L,
wherein ΔL is deformation in a length direction and corresponds to the BLE, and
wherein, based on the Equation 1 and Equation 2, the BLE is expressed in Equation 3 below,
BLE=L/E(σᵣ+EαΔT) Equation 3,
wherein L, E, and EαΔT are constant values defined by a material of the mold pattern, and
wherein the residual stress functions as a variable.

19. The method of claim 16, wherein,
in the calculating the residual stress function,
conditions for the FEM model are configured such that an upper side, a lower side, and a left side of a rectangle are fixed, and an external force is applied to a right side to accumulate a residual stress, and
results obtained by using the FEM model is calculated as the residual stress function by using a high-order polynomial fitting.

20. The method of claim 16, wherein,
in the detecting of the MA, the MA of at least one region among a cell region, an edge region, and a corner region of the unit cell block is detected, and
wherein, in the reflecting of the MA on the mask, the MA is reflected on a mask for forming a support open hole of the capacitor.
